(19) United States
(12) Patent Application Publication
(10) Pub. No.: US 2005/0121391 A1
(43) Pub. Date: Jun. 9, 2005

(54) Reinforced filtration cartridge and method of making same

(76) Inventor: David H. Koch, New York, NY (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 10/672,684

(22) Filed: Sep. 26, 2003

(51) Int. Cl. B01D 63/00; B01D 61/00

(52) U.S. Cl. 210/650; 210/321.8; 210/321.79

(57) ABSTRACT

A reinforced filtration cartridge comprises a housing with end fittings secured at each end of the housing, a membrane bundle extending between the end fittings, and a support column extending between the end fittings, with the ends of the support column secured within potting compound dispersed within each of the end fittings.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The invention relates to filtration, and more particularly to membrane filtration cartridges.

2. Description of the Related Art

Filters are used for the removal of unwanted particles or material from various types of fluids. Typical uses for filters include treatment and purification of drinking water, cleaning and treatment of wastewater for disposal or re-use, and clarification of juices, wines, and beverages. Many types and configurations of filter materials are commonly used, including spiral-wound, hollow fiber, and tubular membranes. Most often, the filter material is enclosed in a housing and the fluid to be treated is forced under pressure through the filter element. The filter element removes unwanted particulates from the fluid, and the treated permeate fluid that passes through the filter element is then removed.

Cartridge filters, in which the filter element is enclosed in a cylindrical housing, represent one common filtration element configuration. In one embodiment of a cartridge filter, fluids are forced through a filter element to a permeate tube which carries the filtered fluid from the cartridge. If a permeate tube is not used, the permeate exits through a side port of the cartridge.

However, cartridge filters are generally restricted to relatively small diameters, typically no larger than five to eight inches, as the pressure required to force the fluid through the filter elements presents a load on the ends of the cartridge as well as on the cartridge housing and the enclosed filter elements. This loading can cause the sides of the housing to bow or break, and can crush the enclosed filter material, decreasing the efficiency and efficacy of the filter. Likewise, the ends of the filter cartridge can break due to excessive loads present in the system. Designs in which reinforcement of the filter elements and end fittings have been attempted have not been widely accepted because the increased size of the reinforced components decreases the area available for filtration material.

### BRIEF SUMMARY OF THE INVENTION

The present invention is directed to a reinforced filtration cartridge that allows the manufacture and use of large diameter filter cartridges which can withstand substantial system pressures without damage, while simultaneously providing a maximum density of filter material within the cartridge. One or more support columns affixed internally of the housing between the ends of the filtration cartridge oppose the forces of compression, allowing cartridges with diameters of up to forty-eight inches to be used without damage to the filter housing or the filter elements contained within. Placement of filtration material within the support columns further increases the amount of filter material within the cartridge. In addition, the support columns allow a reduced potting thickness at the ends of the filter cartridge by providing reinforcement for the potting material, thus further increasing the area available within the cartridge for filter material.

The improved filtration cartridge provides maximum filtration capacity within a minimum footprint cartridge, providing a reduced cost alternative to conventional filter cartridges. This improved filtration cartridge is suitable for any membrane filtration application, including sludge dewatering, laundry wastewater treatment, and clarification of juices. It is particularly adapted to uses where space is at a premium, such as treatment of black, gray, and kitchen wastewater on cruise ships.

In one embodiment of the invention, a reinforced filtration cartridge includes a housing, with two end fittings secured at opposite ends of the housing. A membrane bundle extends through the housing between the first and second end fittings. A support column also extends through the housing between the first and second end fittings, and is embedded and held within potting compound which forms the end caps. The open ends of the membrane bundle extend through the potting compound at each end so that fluid can enter the membrane bundle at either, or both, ends of the filtration cartridge. In use, fluid under pressure is introduced into the membrane bundle through either or both ends of the filtration cartridge. As used herein, fluid includes both liquids and liquids containing amounts of solid materials, such as sludge. The pressurized fluid is forced through the elements of the membrane bundle, with the membrane elements trapping particulates from the fluid and allowing only filtered fluid through. After passing through the membrane bundle, the permeate fluid is removed from the filtration cartridge for use or further processing.

The membrane bundles can be manufactured from various types of filtration materials known in the art. In one embodiment, the membrane bundle is a single tubular membrane. In another embodiment, the membrane bundle is a bundle of tubular membranes. In yet another embodiment, the membrane bundle is comprised of hollow fiber membranes. In another embodiment, the membrane bundle is a combination of tubular membranes and hollow fiber membranes.

In one embodiment of the invention, the potted end caps are formed from potting compound dispersed within the end fittings to harden in place. The potting compound may be epoxy, resin, or any other material known in the art. The potting can be formed in a single layer, or can be comprised of multiple layers of the same or different materials. In another embodiment, the potted end caps are formed by a locator device used to position membrane bundles within the housing. In yet another embodiment, the potted end caps are made from manufactured or preformed tube sheeting.

While the present invention encompasses filtration cartridges of various shapes, in one embodiment the filtration cartridge housing is cylindrical, with cylindrical end fittings.

The support columns can be manufactured from any rigid or semi-rigid material, such as polyvinyl chloride (“PVC”) extruded Fiberglas, Fiberglas-wrapped PVC pipe, PVC pipe filled with epoxy, nylon-fiber wrapped pipe, or composites. They can also be manufactured from either a single material, or constructed from a combination of materials.

In one embodiment of the present invention, the support column is solid or substantially solid, such that no membrane bundles are contained within it.

In another embodiment, multiple support columns extend between the end fittings, providing further reinforcement of the filtration cartridge.

In another embodiment of the present invention, the support column is tubular, with an outer wall and an inner channel. A membrane bundle is placed within the support column, and openings through the wall of the support column allow permeate to pass through the membrane bundle contained within. This arrangement maximizes the membrane area within the filtration cartridge as there is no unutilized space within the support column. Of course, the support column may be any profile or shape which provides rigidity over its length, such as triangular, star-shaped, scallop-shaped, a box channel or an I-beam.

In a further embodiment, netting wrapped around the ends of the tubular support column containing the membrane bundle forms a stand-off for spacing the support column from the housing and from the other support columns. The stand-off netting prevents the smooth outer surface of the support column from contacting the smooth interior surface of the housing or the smooth surface of another support column. Preventing contact of the smooth surfaces prevents potting or adhesive from wicking or racing along the surfaces. In addition, the netting prevents excessive potting or adhesive from wicking into the membrane bundle.

In another embodiment, netting wrapped around the membrane bundle within the support column provides a stand-off of the membrane bundle from the interior surface of the support column, preventing wicking or racing of potting compound or adhesive. In yet another embodiment, the netting is a tubular sock which surrounds the membrane bundle within the support column and extends from the support column at either or both ends, with the netting extending from the support column being wrapped back along the outside surface of the support column. Thus, the single netting sock provides a stand-off for the membrane bundle from the interior surface of the support column as well as a stand-off for the support column from the housing and from other support columns.

In yet another embodiment, multiple tubular support columns contain multiple membrane bundles. Each support column has openings to allow permeate to pass through the contained membrane bundle. Multiple support columns provide additional reinforcement while multiple membrane bundles maximize the density of the membrane available within the filtration cartridge.

In one embodiment of the present invention, the openings in the support column are formed as slots, in another embodiment, they are holes. In yet another embodiment, the openings are a combination of slots and holes.

In a further embodiment of the present invention, additional membrane bundles are packed into the housing, filling any space not used by the support rods and contained membrane bundles. In another embodiment, netting extends around the interior circumference of the housing, encircling the membrane bundles and support columns to form a core assembly comprising the membrane bundles and support rods.

After being forced through the membrane bundles, filtered fluid, or permeate, is available for removal from the filtration cartridge for use or further processing. In one embodiment of the present invention, one or more outlet openings in either one, or both, of the end fittings allows removal of the filtered fluid from the cartridge. In another embodiment, an outlet opening in the cartridge housing allows filtered fluid to be withdrawn.

In another embodiment, a permeate tube with two open ends, and openings through its side walls, extends between the end fittings of the filtration cartridge. Filtered fluid that has passed through the membrane bundles passes through the openings in the side walls of the permeate tube, and flows out of the cartridge through the ends of the permeate tube.

In one embodiment of the present invention, the openings in the permeate tube are formed as slots, in another embodiment, they are holes. In yet another embodiment, the openings are a combination of slots and holes.

### BRIEF DESCRIPTION OF THE DRAWINGS

FIG. 1 is a perspective view of a reinforced filtration cartridge of one embodiment of the present invention.

FIG. 2 is a sectional perspective view of the filtration cartridge of FIG. 1.

FIG. 3 is a close-up perspective view of the upper end the filtration cartridge of FIG. 2.

FIG. 4 is a perspective view of the permeate tube of the filtration cartridge of FIG. 1.

FIG. 5 is a perspective view of a support column of the filtration cartridge of FIG. 1.

FIG. 6 is a perspective view of an alternative embodiment of the present invention in which a membrane bundle comprising tubular membranes is enclosed within a support column.

FIG. 7 is a perspective view of the permeate tube and one support column of the filtration cartridge FIG. 1.

FIG. 8 is a perspective view of the permeate tube and six support columns of the filtration cartridge of FIG. 1.

FIG. 9 is a top view of the filtration cartridge of FIG. 1.

FIG. 10 is a perspective view of an alternative embodiment of the reinforced filtration cartridge of the present invention.

FIG. 11 is a perspective view of the support columns and potted end caps of the filtration cartridge of FIG. 10.

FIG. 12 is a close-up perspective view of one end of the support columns and potted end cap of FIG. 11.

FIG. 13 is an end view of the filtration cartridge of FIG. 10.

### DETAILED DESCRIPTION OF PREFERRED EMBODIMENT

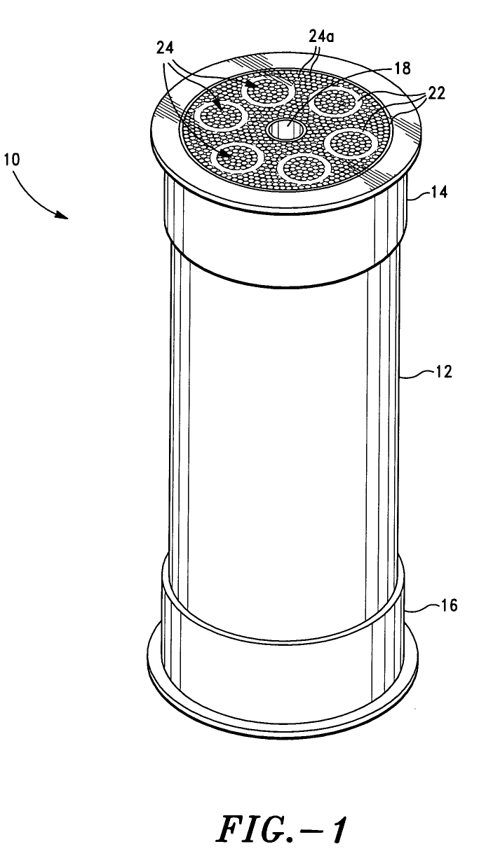

A reinforced filtration cartridge according to an embodiment of the present invention is depicted in FIGS. 1 through 13.

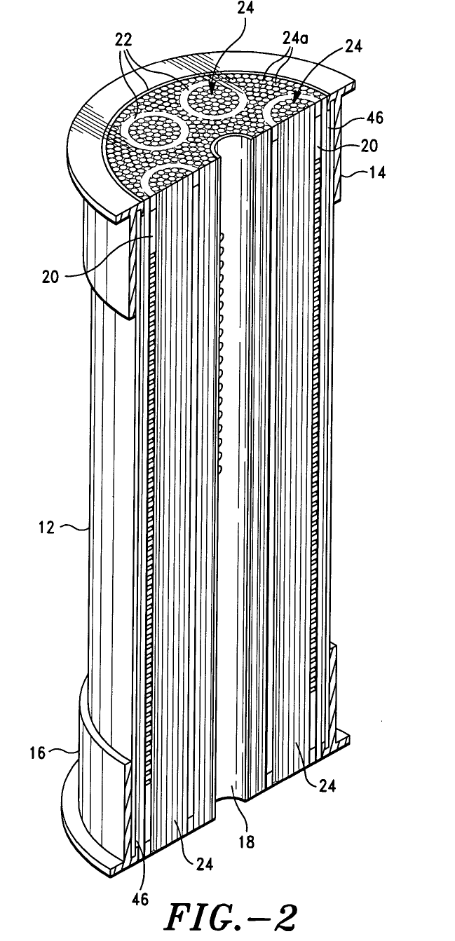

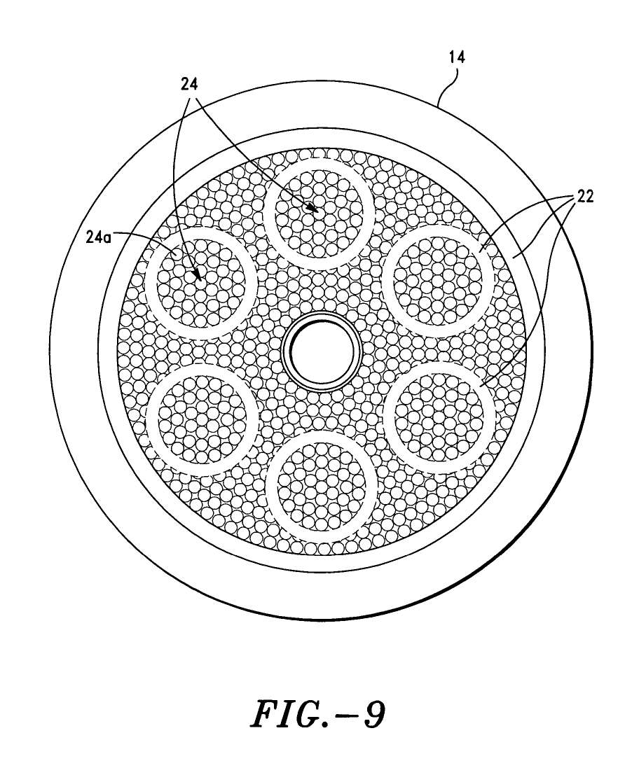

Looking first to FIG. 1, a reinforced filtration cartridge 10 in accordance with an embodiment of the present invention comprises a housing 12, a first end fitting 14, and a second end fitting 16. As best seen in FIG. 2, support columns 20 extend between end fitting 14 and end fitting 16, and are embedded in potting compound 22 which is dispersed in each end fitting. In the embodiment shown, the ends of the support columns 20 are completely embedded within the potting compound 22. Membrane bundles 24, comprised of individual membrane elements 24a, are inserted into each support column 20, extending through the column and through the potting compound 22 at each end of the filtration cartridge 10, such that they are substantially flush with the ends of the cartridge, and the ends of the membrane bundles are exposed as shown in FIG. 9.

As can be seen best in FIG. 9, each membrane bundle is comprised of a plurality of hollow fiber membrane elements 24a. Other filter materials, such as tubular membranes may also be employed without deviating from the scope of the invention.

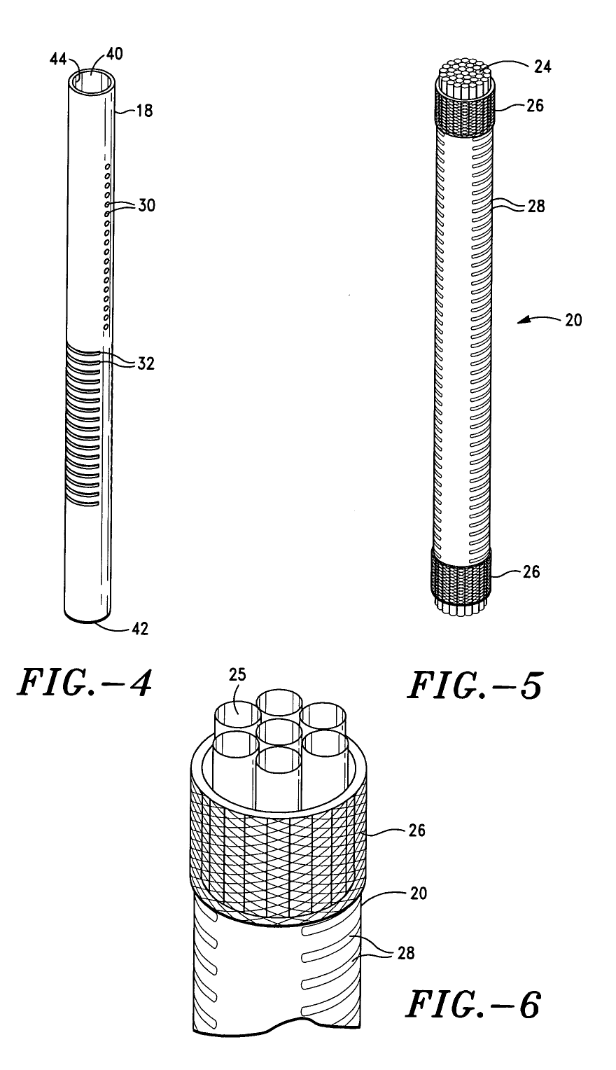

As seen best in FIG. 5, each support column 20 has a plurality of slots 28 extending through the wall of the column, with netting 26 wrapped around the outer circumference at each end of the column 20 to provide stand-off spacing for the support column from housing 12 and other support columns.

FIG. 6 depicts an embodiment of the present invention in which the membrane bundle 24 comprises a plurality of tubular membrane elements 25.

Turning again to FIG. 1, Permeate tube 18 extends through the housing 12, with opposite ends extending through the first and second end fittings 14, 16 and through the potting compound 22 at each end fitting, so that the ends of permeate tube 18 are substantially flush with the ends of the filtration cartridge 10.

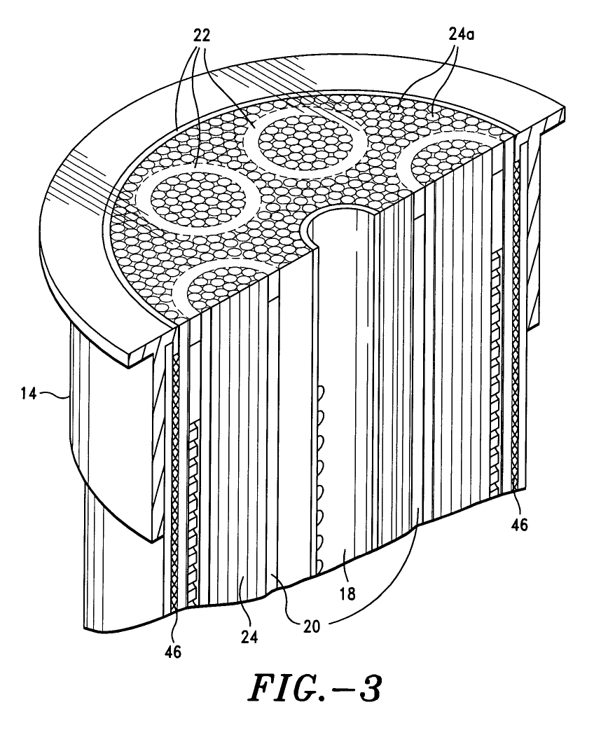

Looking to FIG. 4, permeate tube 18 has first and second open ends 40, 42, an inner channel 44, and includes holes 30 and slots 32 through the tube to the inner channel 44.

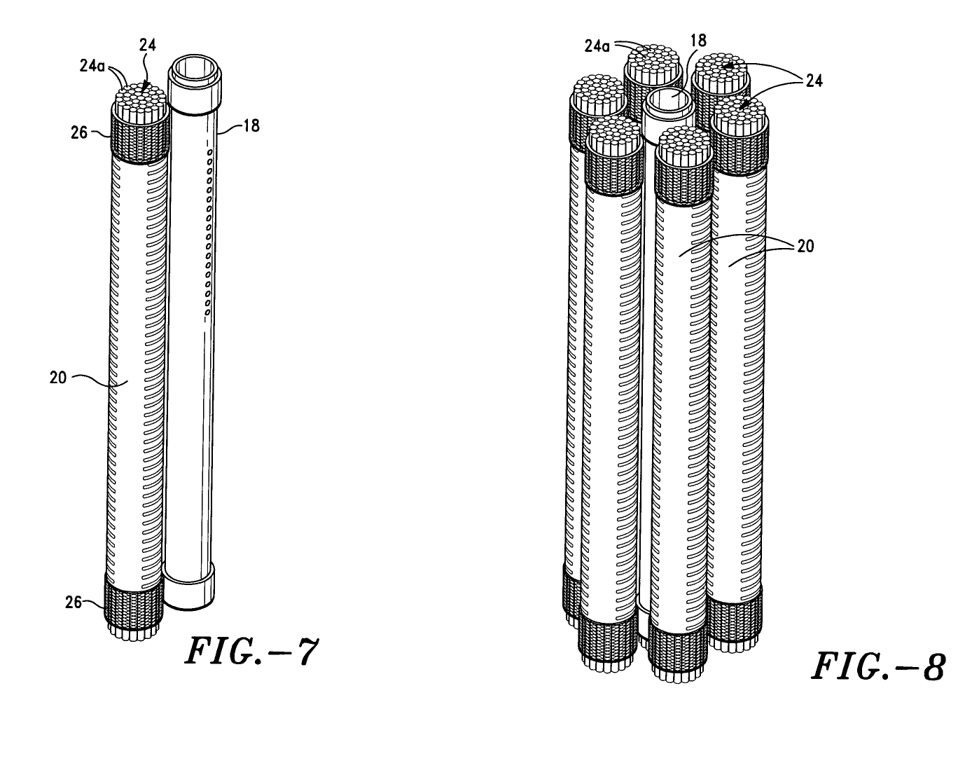

FIGS. 7 and 8, respectively, depict permeate tube 18 located in proximity to a single and multiple support columns 20, respectively. Spaces between and surrounding support columns 20 and permeate tube 18 may be filled with additional membrane elements 24a in order to maximize the membrane area within filtration cartridge 10. As seen in FIGS. 2 and 3, netting 46 may be wrapped around the outer circumference of the entire assembly of membrane bundles 24, support columns 20, and permeate tube 18 to help hold them together within the housing 10.

In use, fluid to be filtered is introduced under pressure into the membrane bundles 24 at the ends of the filtration cartridge 10. As the fluid is forced through the membrane bundles 24, the membrane bundles will reject materials, allowing only filtered fluid to pass through. Filtered fluid (permeate), which has passed through the membrane bundles 24 then passes through the slots 28 in the support column, and through the holes 30 and slots 32 in permeate tube 18 before exiting through one or both open ends 40, 42.

While the embodiment depicted utilizes permeate tube 18 to direct filtered fluid from the cartridge, those skilled in the art will appreciate that other methods of removing the permeate may be employed without varying from the scope of the present invention. For example, in alternative embodiments, permeate that has passed through the membrane bundles may be removed through one or more openings in either or both end fittings, through one or more openings in the housing, or through combinations of such openings.

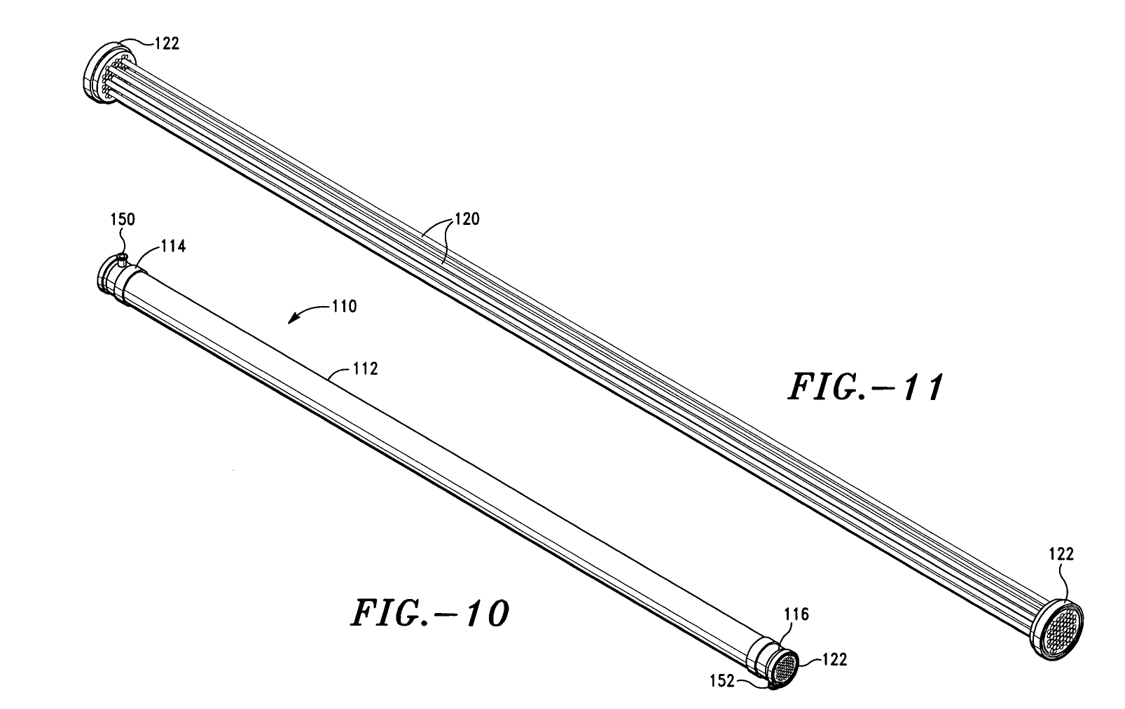

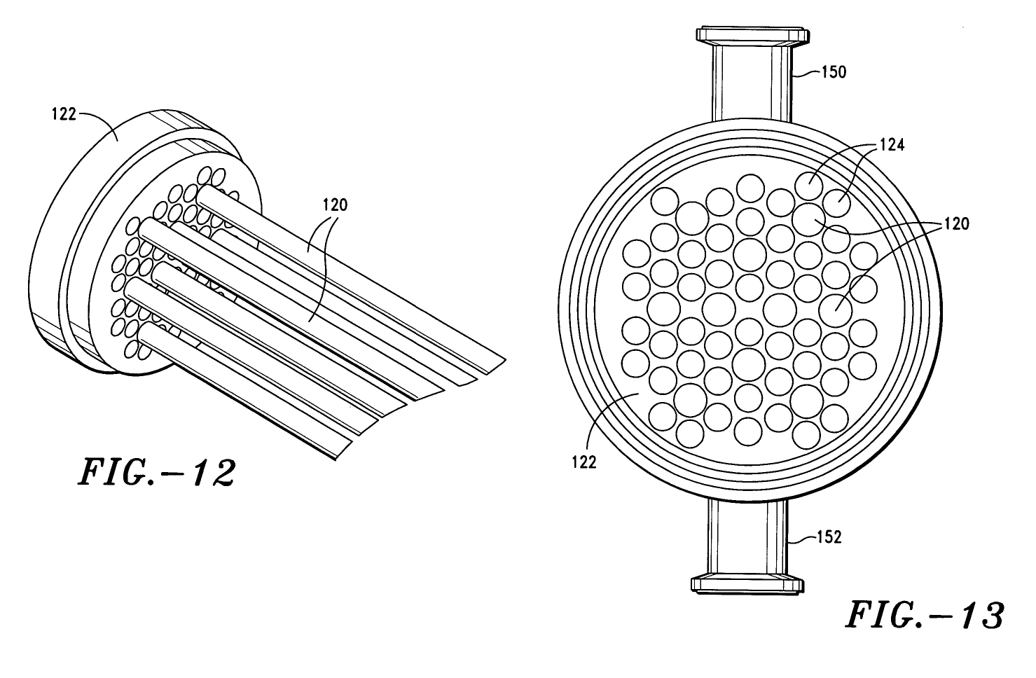

FIGS. 10 through 13 depict an alternative embodiment of a reinforced filtration cartridge 110 having a housing 112, first and second end fittings 114, 116 with outlet fittings 150 located at each of the end fittings. As seen in FIGS. 11 and 12, a plurality of support columns 120, which are solid rods, extend the length of the filtration cartridge 110, with the ends of the support columns 120 embedded within, but not extending through, potting compound 122 at each end of the cartridge. As shown in FIG. 13, the support columns 120, are located within the filtration cartridge to provide support across the entire area of the potting compound 122 so that the distance between support columns within the potted end is minimal. This allows the thickness of the potting compound 122 at each end of the filtration cartridge to be minimized, thus maximizing the area within the filtration cartridge available for filtration material. As also shown in FIG. 13, additional membrane bundles 124, shown as tubular membranes, are packed into the area surrounding the support columns. For clarity in the drawings, the support columns are shown as having a larger diameter than the membrane bundles, however it is understood that the support columns may be smaller, larger, or the same diameter as the membrane bundles without deviating from the scope of the invention.

In use, fluid or sludge to be filtered is introduced under pressure into the membrane bundles 124 at the ends of the filtration cartridge 110. As the fluid is forced through the bundles, solids and particulates are trapped in the membrane. Filtered fluid (permeate), which has passed through the membrane bundles 124 exits through the fittings 150 at either end of the filtration cartridge 110

Embodiments of the reinforced filtration cartridge of the present invention allow the manufacture and use of large diameter filtration cartridges which can withstand substantial system pressures without damage, while simultaneously providing a maximum density of filtration material within a small-footprint cartridge particularly capable of uses where space is at a premium, such as on cruise ships. The reinforced filtration cartridges provide a reduced cost alternative to conventional cartridges, and are suitable for any membrane filtration application, including sludge dewatering, treatment of black, gray, kitchen and laundry wastewater, and clarification of juices.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and sub-combinations are of utility and may be employed without reference to other features and sub-combinations. This is contemplated by and is within the scope of the claims.

The term “substantially” and “approximately” as used herein may be applied to modify any quantitative representation which could permissibly vary without resulting in a change in the basic function to which it is related. For example, the housing and end fittings disclosed herein as being substantially cylindrical may permissibly be somewhat non-cylindrical and still be within the scope of the invention if the variance from cylindrical does not materially alter the capability of the invention. Likewise, the variance from any quantitative representation, such as proximate, solid, longitudinal, or parallel as used with respect to the support columns and membrane bundles herein, is permissible if the variance does not materially alter the capability of the invention.

1. A reinforced filtration cartridge having an inlet for receiving fluid to be filtered, and an outlet for removing filtered fluid, said cartridge comprising:
a housing having first and second ends and an interior surface;
first and second end fittings secured respectively to said first and second ends of said housing;
a potted end cap disposed within each of said first and second end fittings;
at least one membrane bundle extending between said first and second end fittings, said membrane bundle being coupled with said inlet; and
at least one support column having first and second ends extending between said first and second end fittings, such that said first and second ends are embedded within said potted end cap without extending through said potted end cap.

2. The filtration cartridge of claim 1, wherein said at least one membrane bundle comprises at least one tubular membrane.

3. The filtration cartridge of claim 1, wherein said at least one membrane bundle comprises a plurality of hollow fiber membranes.

4. The filtration cartridge of claim 1, wherein said at least one support column is substantially solid.

5. The filtration cartridge of claim 1, wherein said housing and said first and second end fittings are substantially cylindrical.

6. The filtration cartridge of claim 1, wherein said at least one membrane bundle comprises at least two membrane bundles, and wherein said at least one support column comprises a tube having an outer wall and an inner channel, and wherein at least one of said at least one membrane bundles is contained within said support column.

7. The filtration cartridge of claim 6, wherein said at least two membrane bundles each comprise at least one tubular membrane.

8. The filtration cartridge of claim 6, wherein said at least two membrane bundles comprise a plurality of hollow fiber membranes.

9. The filtration cartridge of claim 6, wherein said at least one support column comprises at least two support columns, and wherein at least one of said at least two membrane bundles is contained within at least one of said at least two support columns.

10. The filtration cartridge of claim 6, further comprising netting extending circumferentially around said interior surface of said housing.

11. The filtration cartridge of claim 6, wherein said support column includes openings through said outer wall to said inner channel.

12. The filtration cartridge of claim 11, wherein said openings comprise slots.

13. The filtration cartridge of claim 11, wherein said openings comprise holes.

14. The filtration cartridge of claim 11, wherein said openings comprise slots and holes.

15. The filtration cartridge of claim 6, further comprising netting extending circumferentially around each of said first and second ends of said at least one support column.

16. The filtration cartridge of claim 6, further comprising netting extending circumferentially around said at least one contained membrane bundle.

17. The filtration cartridge of claim 6 further comprising netting extending circumferentially around said at least one contained membrane bundle, wherein said netting extends beyond and folds back around at least one end of said at least one support column.

18. The filtration cartridge of claim 1, further comprising at least one permeate tube for receiving and removing permeate which has passed through said membrane bundle, said permeate tube being coupled with said outlet.

19. The filtration cartridge of claim 18, wherein said at least one permeate tube extends between said first and second end fittings such that the outer surface of said permeate tube adjacent each of said first and second open ends is embedded in said potted end caps.

20. The filtration cartridge of claim 19, wherein said at least one permeate tube includes openings through said outer surface to said inner channel.

21. The filtration cartridge of claim 20, wherein said openings comprise slots.

22. The filtration cartridge of claim 20 wherein said openings comprise holes.

23. The filtration cartridge of claim 20 wherein said openings comprise slots and holes.

24. A reinforced filtration cartridge having an inlet for receiving fluid to be filtered, and an outlet for removing filtered fluid, said cartridge comprising:
a substantially cylindrical housing having an interior surface and first and second ends;
first and second end fittings, wherein each of said end fittings is substantially cylindrical;
potting compound disposed within each of said first and second end fittings;
at least two tubular support columns, each comprising first and second ends, an outer wall and an inner channel, and openings through said outer wall to said inner channel, wherein said at least two tubular support columns extend between said first and second end fittings, such that said first and second ends are embedded in said potting compound without extending through said potting compound;
at least three membrane bundles extending between said first and second end fittings, wherein at least one of said at least three membrane bundles is contained within each of said at least two tubular support columns, said membrane bundles being coupled with said inlet; and
at least one permeate tube within said cartridge for receiving and removing permeate which has passed through said membrane bundle, said permeate tube being coupled with said outlet.

25. The filtration cartridge of claim 24, wherein said at least three membrane bundles each comprise at least one tubular membrane.

26. The filtration cartridge of claim 24, wherein said at least three membrane bundles comprise a plurality of hollow fiber membranes.

27. A method of making a reinforced filtration cartridge having a housing for a filtration membrane, said method comprising the steps of:
positioning a support column within said housing;
packing membrane bundles within said housing proximate said support column;
placing first and second end fittings on opposing ends of said housing; and
dispersing potting compound into each of said first and second end fittings to form end caps such that the ends of said support column are embedded within said potting compound.

28. The method of making a reinforced filtration cartridge of claim 27, wherein said membrane bundles comprise at least one tubular membrane.

29. The method of making a reinforced filtration cartridge of claim 27, wherein said membrane bundles comprise a plurality of hollow fiber membranes.

30. The method of making a reinforced filtration cartridge of claim 27, further comprising the step of:
inserting a membrane bundle into said support column;

31. The method of making a reinforced filtration cartridge of claim 27, further comprising the step of wrapping netting around each end of said support column.

32. A method of filtering a fluid utilizing a cartridge filled with a filtration membrane, said method comprising the steps of:
arranging said filtration membrane in a plurality of longitudinally extending parallel bundles within said cartridge;
providing a permeate tube in said cartridge for receiving and removing permeate which has passed through said filtration membrane;
placing at least one support column within said cartridge to provide structural strength to said cartridge;
potting the ends of said cartridge to support said bundles;
embedding the ends of said at least one support column within said potting compound while not allowing said ends to pass through the potting compound; and
passing said fluid to be filtered through said cartridge.

33. The method of claim 32, wherein said filtration membrane comprises hollow fiber membranes.

34. The method of claim 32, wherein said filtration membrane comprises at least one tubular membrane.

35. A method of filtering a fluid utilizing a cartridge filled with a filtration membrane, said method comprising the steps of:
arranging said filtration membrane in a plurality of longitudinally extending parallel bundles within said cartridge;
providing at least one opening within said cartridge for receiving and removing permeate which has passed through said filtration membrane;
placing at least one support column within said cartridge to provide structural strength to said cartridge;
potting the ends of said cartridge to support said bundles;
embedding the ends of said at least one support column within said potting compound while not allowing said ends to pass through the potting compound; and
passing said fluid to be filtered through said cartridge.

36. The method of claim 35, wherein said filtration membrane comprises hollow fiber membranes.

37. The method of claim 35, wherein said filtration membrane comprises at least one tubular membrane.

38. A method of sludge dewatering utilizing a cartridge filled with a filtration membrane, said method comprising the steps of:
arranging said filtration membrane in a plurality of longitudinally extending parallel bundles within said cartridge;
providing a permeate tube in said cartridge for receiving and removing permeate which has passed through said filtration membrane;
placing at least one support column within said cartridge to provide structural strength to said cartridge;
potting the ends of said cartridge to support said bundles;
embedding the ends of said at least one support column within said potting compound while not allowing said ends to pass through the potting compound; and
passing said sludge to be dewatered through said cartridge.

39. The method of claim 38, wherein said filtration membrane comprises hollow fiber membranes.

40. The method of claim 38, wherein said filtration membrane comprises at least one tubular membrane.

41. A method of sludge dewatering utilizing a cartridge filled with a filtration membrane, said method comprising the steps of:
arranging said filtration membrane in a plurality of longitudinally extending parallel bundles within said cartridge;
providing at least one opening within said cartridge for receiving and removing permeate which has passed through said filtration membrane;
placing at least one support column within said cartridge to provide structural strength to said cartridge;
potting the ends of said cartridge to support said bundles;
embedding the ends of said at least one support column within said potting compound while not allowing said ends to pass through the potting compound; and
passing said sludge to be dewatered through said cartridge.

42. The method of claim 41, wherein said filtration membrane comprises hollow fiber membranes.

43. The method of claim 41, wherein said filtration membrane comprises at least one tubular membrane.
